(19) United States
(12) Patent Application Publication
(10) Pub. No.: US 2018/0314673 A1
(43) Pub. Date: Nov. 1, 2018

(54) System and Method for Capturing and Processing Image and Text Information

(71) Applicant: Arya Ghadimi, Toronto (CA)

(72) Inventor: Arya Ghadimi, Toronto (CA)

(21) Appl. No.: 15/789,894

(22) Filed: Oct. 20, 2017

Related U.S. Application Data
(60) Provisional application No. 62/410,841, filed on Oct. 20, 2016.

(51) Int. Cl. G06F 17/21; G06F 17/24; G06F 17/27; G06Q 50/18; G06N 3/08

(52) U.S. Cl. CPC G06F 17/211; G06F 17/24; G06K 9/00469; G06Q 50/184; G06N 3/08; G06F 17/2765

(57) ABSTRACT

There is provided a method and system for preparing a patent application. The system comprises an image processing engine, a text processing engine, a typesetting engine, and an input terminal in communication with the text processing engine and the image processing engine. The system also comprises a memory in communication with one or more of the above components. The image processing engine is configured to process the image data to generate processed image data having one or more of figure numbers, lead lines and component numbers added to the image data. The text processing engine is configured to process the text data to generate processed text data comprising the text data formatted as a description corresponding to the image data. The typesetting engine is configured to arrange the processed image data and the processed text data to generate a document in a format acceptable by a given patent office.

### CROSS-REFERENCE TO RELATED APPLICATION

This application claims the benefit of U.S. Provisional Patent Application No. 62/410,841 filed on Oct. 20, 2016, which is incorporated herein in its entirety.

### FIELD

This specification is related to systems and methods for capturing and processing image and text information, and in particular to systems and methods for capturing and processing image and text information to prepare a patent application.

### BACKGROUND

Manual preparation of legal and/or formal documents based on complicated technical facts can be time consuming, expensive, and prone to structural, stylistic, legal errors. Making these documents easier to prepare and less prone to errors can be them accessible to larger client bases.

### SUMMARY

According to a aspect of the present specification there is provided a system for preparing a patent application, the system comprising: an image processing engine; a text processing engine, an input terminal in communication with the text processing engine and the image processing engine; a memory in communication with one or more of the image processing engine, the text processing engine, and the input terminal, the memory configured for storing one or more of text data and image data; a typesetting engine; wherein: the input terminal is configured to receive one or more of image data and text data, and to communicate the image data and the text data to one or more of the image processing engine, the text processing engine, and the memory; the image processing engine is configured to receive the image data from one or more of the input terminal and the memory, and to process the image data to generate processed image data comprising one or more of figure numbers added to the image data; lead lines added to the image data; and component numbers added to the image data; the text processing engine is configured to receive the text data from one or more of the input terminal and the memory, and to process the text data to generate processed text data comprising the text data formatted as a description corresponding to the image data; and the typesetting engine is configured to arrange the processed image data and the processed text data to generate a document in a format acceptable by a given patent office.

According to another aspect of the present specification there is provided a method for preparing a patent application, the method comprising: receiving at an input terminal one or more of image data and text data; communicating the image data and the text data to one or more of an image processing engine, a text processing engine, and a memory; processing the image data at the data processing engine to generate processed image data comprising one or more of: figures numbers added to the image data; lead lines added to the image data; and component numbers added to the image data; processing the text data at the text processing engine to generate processed text data comprising the text data formatted as a description corresponding to the image data; and arranging the processed image data and the processed text data at a typesetting engine to generate a document in a format acceptable by a given patent office.

According to another aspect of the present specification there is provided a computer readable medium comprising computer readable instructions configured to cause a computing system to carry out a method for preparing a patent application, the method comprising: receiving at an input terminal one or more of image data and text data; communicating the image data and the text data to one or more of an image processing engine, a text processing engine, and a memory; processing the image data at the data processing engine to generate processed image data comprising one or more of: figure numbers added to the image data; lead lines added to the image data; and component numbers added to the image data; processing the text data at the text processing engine to generate processed text data comprising the text data formatted as a description corresponding to the image data; and arranging the processed image data and the processed text data at a typesetting engine to generate a document in a format acceptable by a given patent office.

### BRIEF DESCRIPTION OF DRAWINGS

Some implementations of the present specification will now be described, by way of example only, with reference to the attached Figures, wherein:

FIG. 1 shows a screen capture of an exemplary application implementing the systems and methods of the present specification, according to non-limiting implementations.

FIG. 2 shows another screen capture of the exemplary application implementing the systems and methods of the present specification, according to non-limiting implementations.

FIG. 3 shows another screen capture of the exemplary application implementing the systems and methods of the present specification, according to non-limiting implementations.

FIG. 4 shows another screen capture of the exemplary application implementing the systems and methods of the present specification, according to non-limiting implementations.

FIG. 5 shows another screen capture of the exemplary application implementing the systems and methods of the present specification, according to non-limiting implementations.

FIG. 6 shows another screen capture of the exemplary application implementing the systems and methods of the present specification, according to non-limiting implementations.

FIG. 7 shows another screen capture of the exemplary application implementing the systems and methods of the present specification, according to non-limiting implementations.

FIG. 8 shows another screen capture of the exemplary application implementing the systems and methods of the present specification, according to non-limiting implementations.

FIG. 9 shows another screen capture of the exemplary application implementing the systems and methods of the present specification, according to non-limiting implementations.

FIG. 10 shows another screen capture of the exemplary application implementing the systems and methods of the present specification, according to non-limiting implementations.

FIG. 11 shows another screen capture of the exemplary application implementing the systems and methods of the present specification, according to non-limiting implementations.

FIG. 12 shows another screen capture of the exemplary application implementing the systems and methods of the present specification, according to non-limiting implementations.

FIG. 13 shows another screen capture of the exemplary application implementing the systems and methods of the present specification, according to non-limiting implementations.

FIG. 14 shows another screen capture of the exemplary application implementing the systems and methods of the present specification, according to non-limiting implementations.

FIG. 15 shows another screen capture of the exemplary application implementing the systems and methods of the present specification, according to non-limiting implementations.

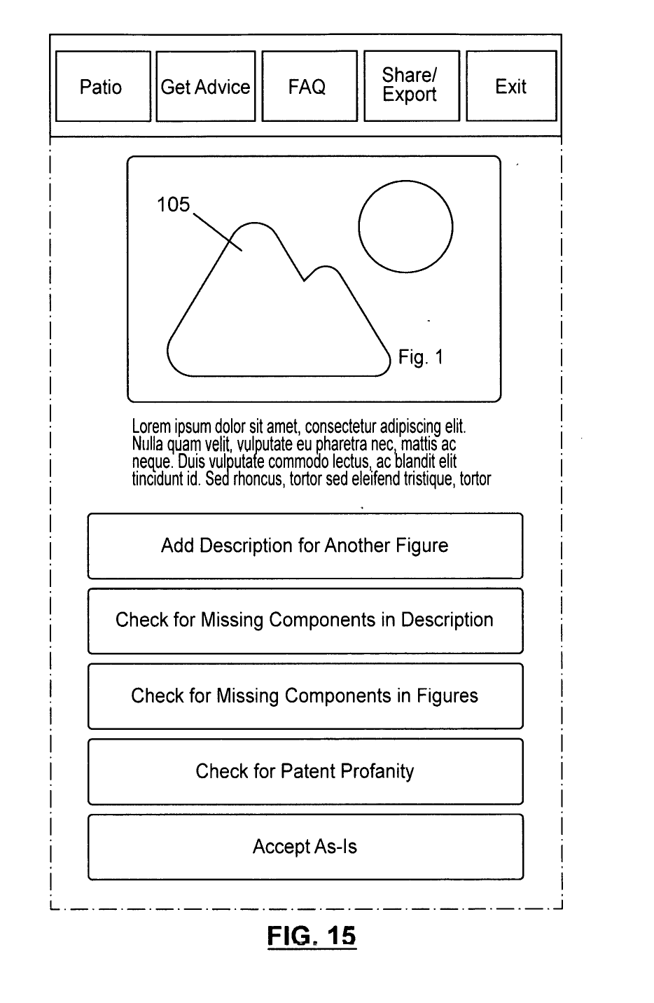

FIG. 16 shows another screen capture of the exemplary application implementing the systems and methods of the present specification, according to non-limiting implementations.

FIG. 17 shows another screen capture of the exemplary application implementing the systems and methods of the present specification, according to non-limiting implementations.

FIG. 18 shows another screen capture of the exemplary application implementing the systems and methods of the present specification, according to non-limiting implementations.

FIG. 19 shows another screen capture of the exemplary application implementing the systems and methods of the present specification, according to non-limiting implementations.

FIG. 20 shows another screen capture of the exemplary application implementing the systems and methods of the present specification, according to non-limiting implementations.

FIG. 21 shows another screen capture of the exemplary application implementing the systems and methods of the present specification, according to non-limiting implementations.

FIG. 22 shows another screen capture of the exemplary application implementing the systems and methods of the present specification, according to non-limiting implementations.

FIG. 23 shows another screen capture of the exemplary application implementing the systems and methods of the present specification, according to non-limiting implementations.

FIG. 24 shows another screen capture of the exemplary application implementing the systems and methods of the present specification, according to non-limiting implementations.

### DETAILED DESCRIPTION

This systems and methods described here allow for capturing and process image, text, and/or voice information in order to assist with preparing and filing a patent application. In addition, it allows for automatically filing the patent application. Moreover, it also allows for extracting keywords and performing a prior art search to provide the user with a novelty score. The application also checks for patent profanities, i.e. for language in a patent description that can be prejudicial in the prosecution and/or enforcement of the patent application and/or the patent.

While the implementation described below shows screen shots of a mobile application (“app”) that implements the systems and methods of the present specification, it is contemplated that the present specification is not limited to mobile apps. It is contemplated that the system and method of the present specification can be implemented using any other computing device such as desktop computer, laptop computer, mobile computing device, the cloud, and any other suitable computing device.

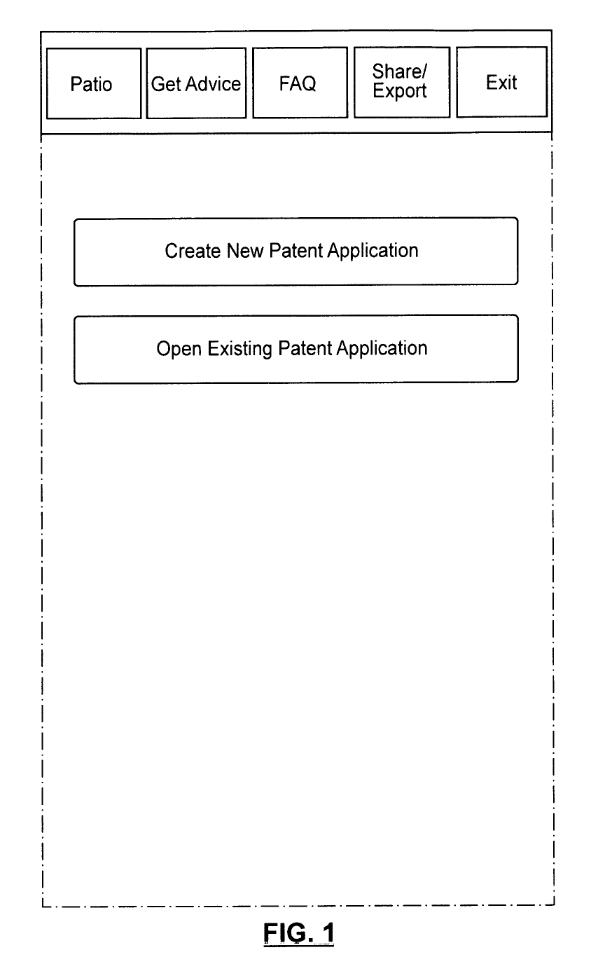

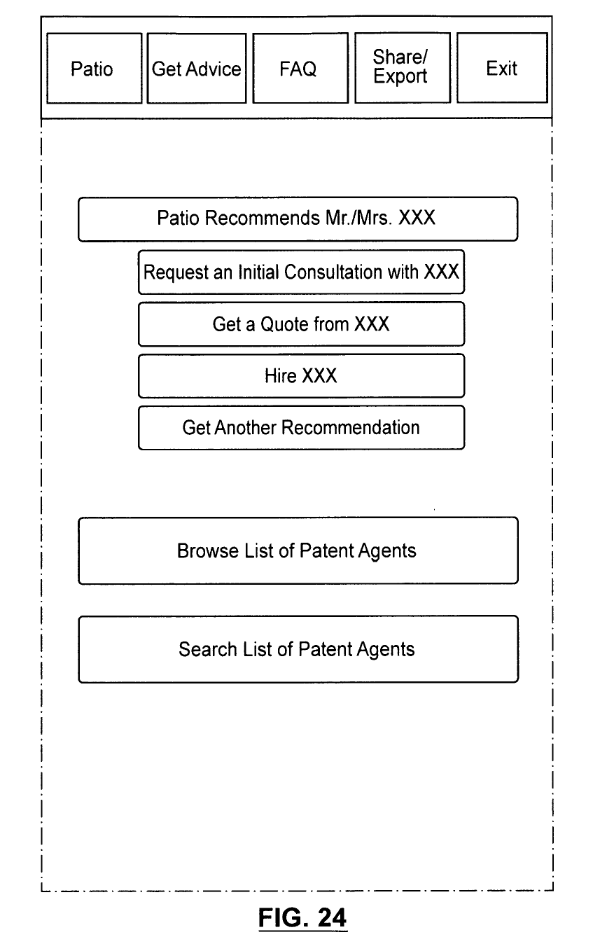

FIG. 1 shows the landing page of the app, which comprises a menu (shown at the top) and options for creating a new application and opening an existing patent application. The menu comprises a name for the app, in this case shown as “Patio”, but can be any other suitable name. The menu also comprises a get advice button, a FAQ button, a Share/Export button, and an Exit button. The Get Advice button can take the user to FIG. 24, which provides options for contacting a qualified patent agent.

Under a first set of options, the app can recommend a patent agent, and can provide options for the user to request a consultation, get a quote from, and/or hire the recommended agent. The app can also provide the option of getting a different recommendation. These recommendations can be based on top user reviews, proximity to user (measured from address of user or GPS location of the mobile device), costs to hire/consult the agent, allowance success rates of the agent, average number of office actions and/or the length of pendency time to allowance achieved by the agent, a paid subscription system where agents can pay to be the recommended agent, and any other suitable ranking or referral scheme. In addition, the app provides the option of browsing and/or searching a list of agents, either all qualified agents in a given jurisdiction or those agents who have signed up with the app.

The FAQ option can provide information about operation of the app, the patent system of a given jurisdiction, and/or tips for preparing a patent application. The Share/Export option can allow a user to share a manuscript with others, such as co-inventors who may want to work on and/or review the document. This option can also allow the inventor to share the manuscript with potential investors, and other interested parties. In such a case, the share/export option can automatically present the investor, etc. with a non-disclosure agreement and obtain consent of the investor with the NDA before making the manuscript available to the investor. This is not limited to investors and can apply to any interested parties such as joint venturers, etc. The user can also export the manuscript (completed or partial) in editable or non-editable formats for completion and/or review through different devices and/or user interfaces.

The Exit option can provide both Save-and-Exit and Destroy-and-Exit options. The destroy-and-exit option can allow an inventor to remove and/or erase sensitive and/or confidential information regarding the invention from the app the device, and/or the cloud and/or servers that the device might be communicating with.

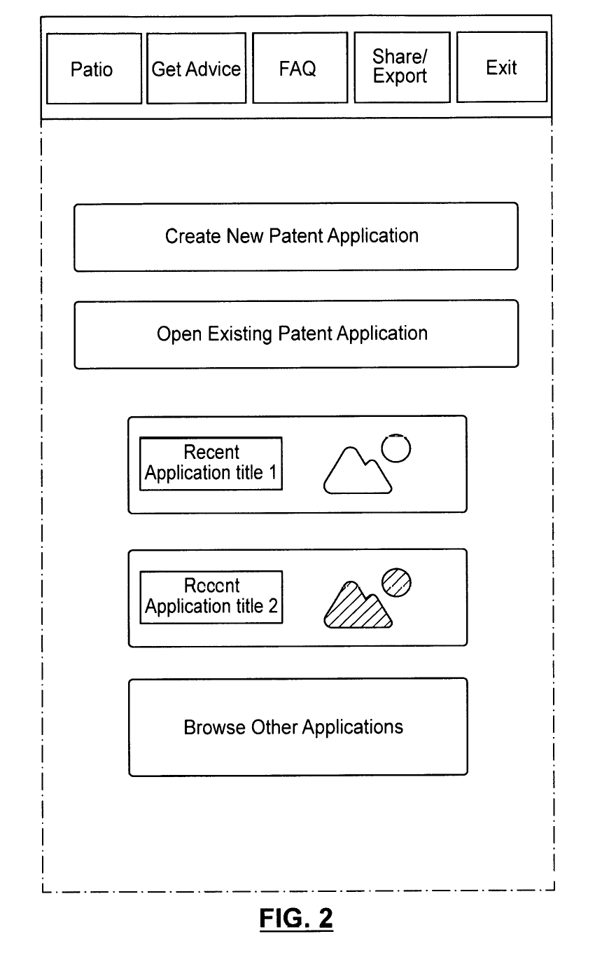

Open existing patent application option can take the user to FIG. 2 where a list of recent patent application(s) (and optionally sample drawing(s) associated with them) can be presented for choosing and opening.

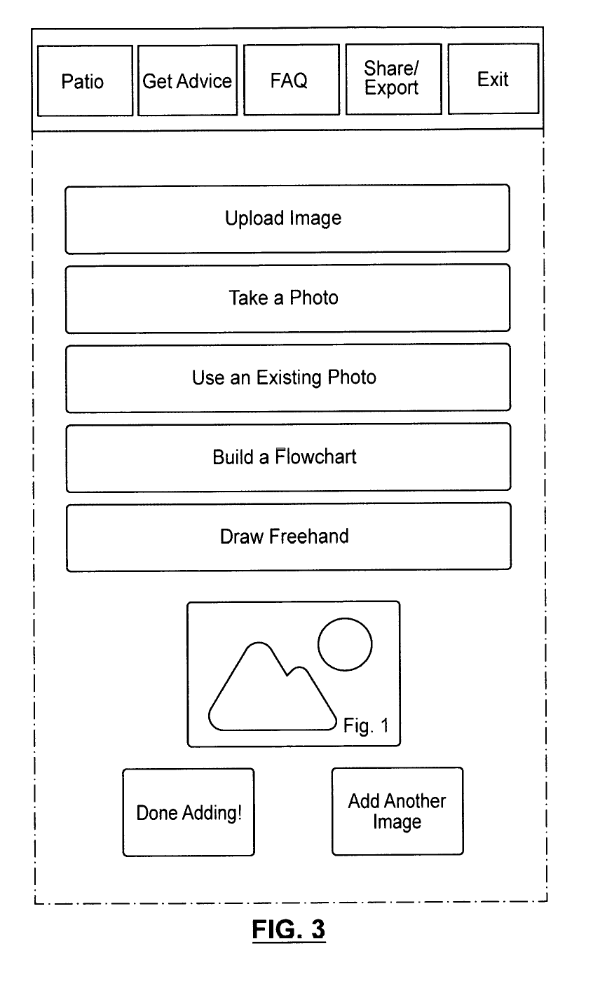

Create new patent application can take the user to FIG. 3, where the user can start preparing the application by adding image data which can form, or can be used to form, the drawings of the patent application. Image data can be uploaded from an external source, captured through the camera of the mobile device, or selected from among existing images saved on and/or accessible through the mobile device. In addition, image data can be in the form of a flow chart drawn by the user using the mobile device interface, or in the form of a free hand drawing(s) drawn using the touch screen by finger or stylus pen of the mobile device.

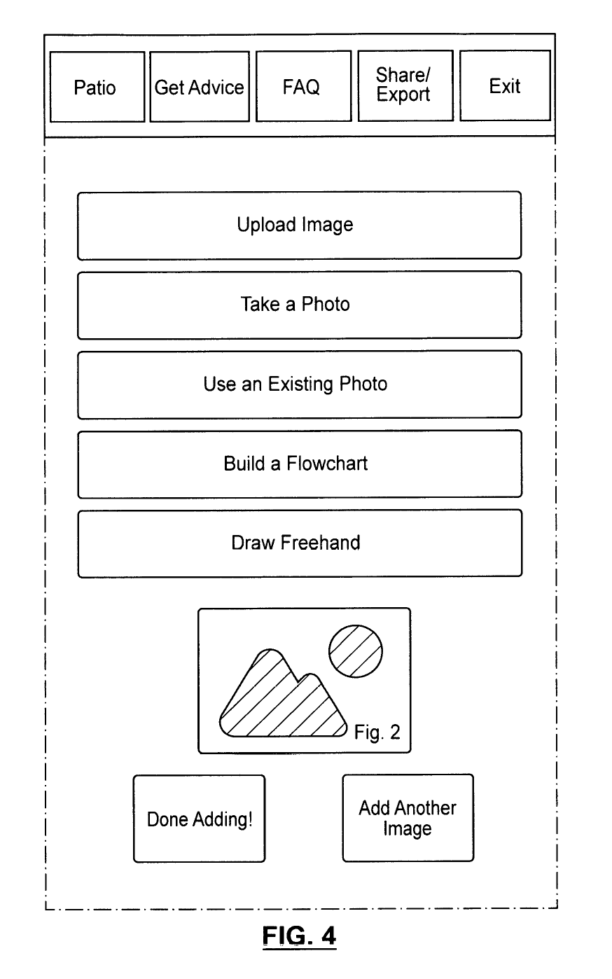

Once the image data is added, it can be given a “Fig.” number as shown in the screen capture of FIG. 3. FIG. 3 also can present options of “done adding” and “add another image”. FIG. 4 shows the screen that the user can see if she chooses to add another image, and FIG. 4 shows “FIG. 2” uploaded by the user.

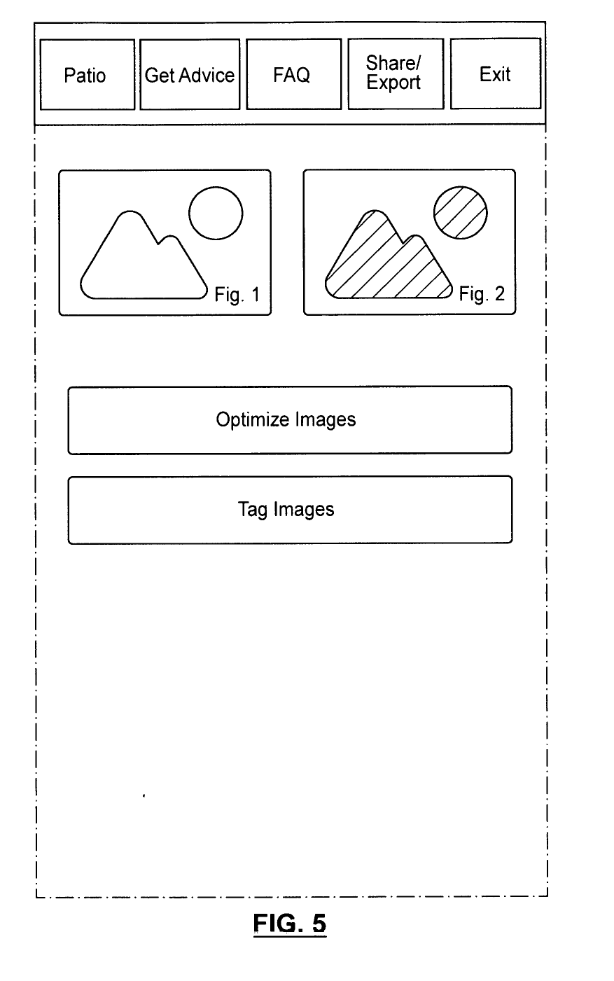

FIG. 5 provides an option to the user to optimise images added using the app. Such optimization can be configured to make the image more suitable for use as a drawing of a patent application. Some non-limiting examples of this optimization include: converting the image to black-and-white and/or grey-scale; converting an image into a line drawing; correcting margins of an image according to patent office specifications; ensuring the image does not include unacceptable embedded fonts; detecting fine and/or faint visual features (e.g. small letters/numbers/symbols and thin or faint lines) that may not reproduce well when the application is added to the patent office records/databases, and the like.

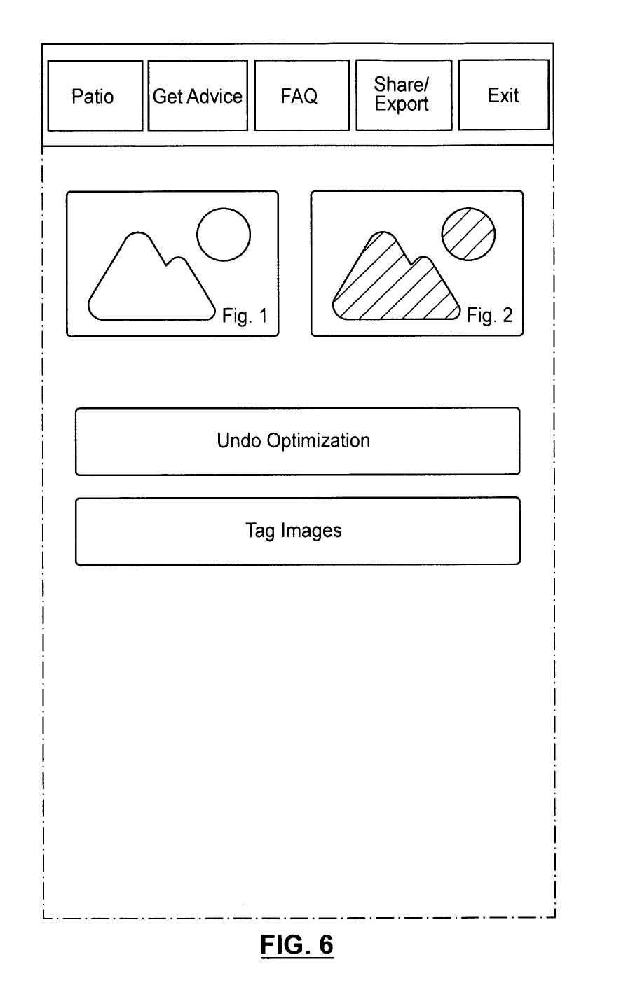

If the user chooses to optimize, the optimized images can be shown in a screen shown in FIG. 6, which also provides an option to undo the optimization in case the optimizations distort and/or change the drawings in a manner not acceptable to the user.

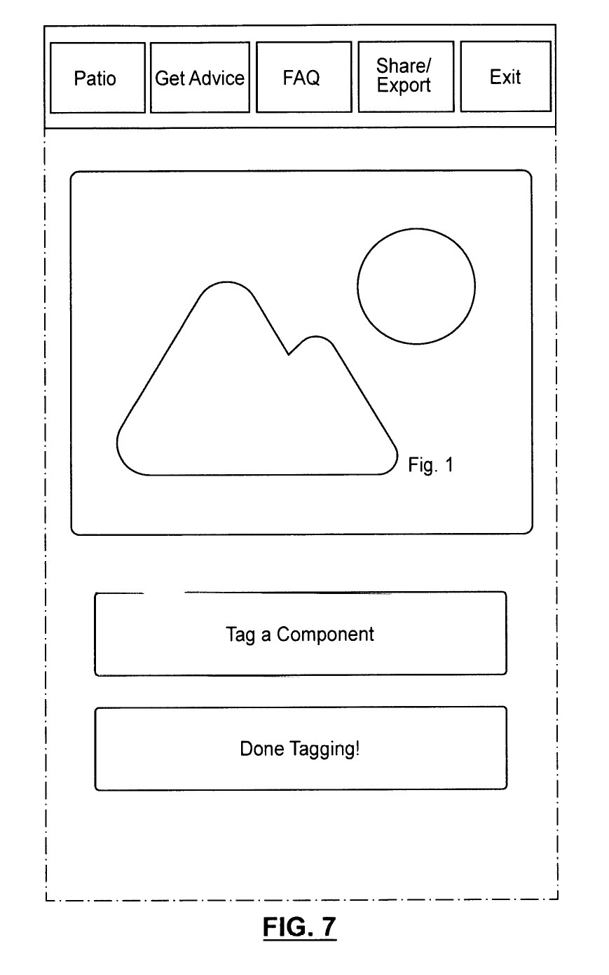

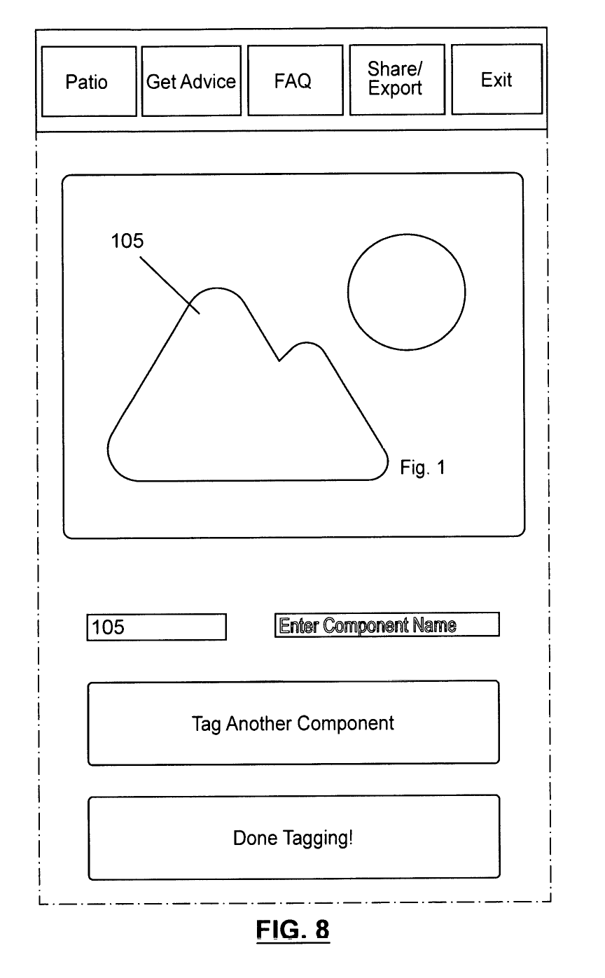

FIG. 7 can provide the option to tag an image by adding lead lines and component numbers to signify a particular feature and/or component in the drawings. If the “tag” option is chosen, the user can be taken to FIG. 8 where by touch input on the touch screen or mouse click on a desktop, etc.) the user can specify what feature is to be tagged. The app can automatically draw the lead line and insert a component number. The app can also provide a text entry box for the user to enter the component name for the tagged feature. The app can also provide options to continue tagging or “done tagging”.

The app can be configured to detect the outer perimeter of the drawing (i.e. the outer envelope of the drawing) and situate the end of the lead lines and the corresponding component numbers outside the drawing, i.e. outside the outer envelope. In addition, the app can ensure that no lead lines cross each other and that the component numbers do not overlap other component numbers or features in the drawings.

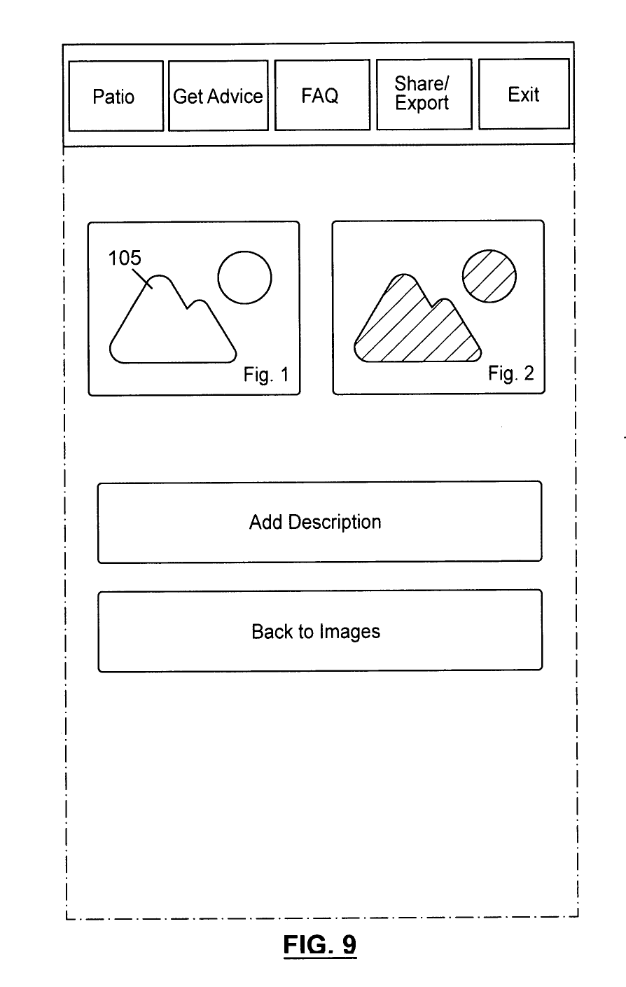

FIG. 9 shown “FIG. 1” added by the user and tagged with lead in-component number “105”. The screen shown in FIG. 9 can be shown to the user when the user selects “done tagging” in the screen shown in FIG. 8. In FIG. 9, the user can be provided with the option of adding description corresponding to a drawing, which can be a tagged drawing. Otherwise, the user can be given the option to go back to adding and/or tagging images.

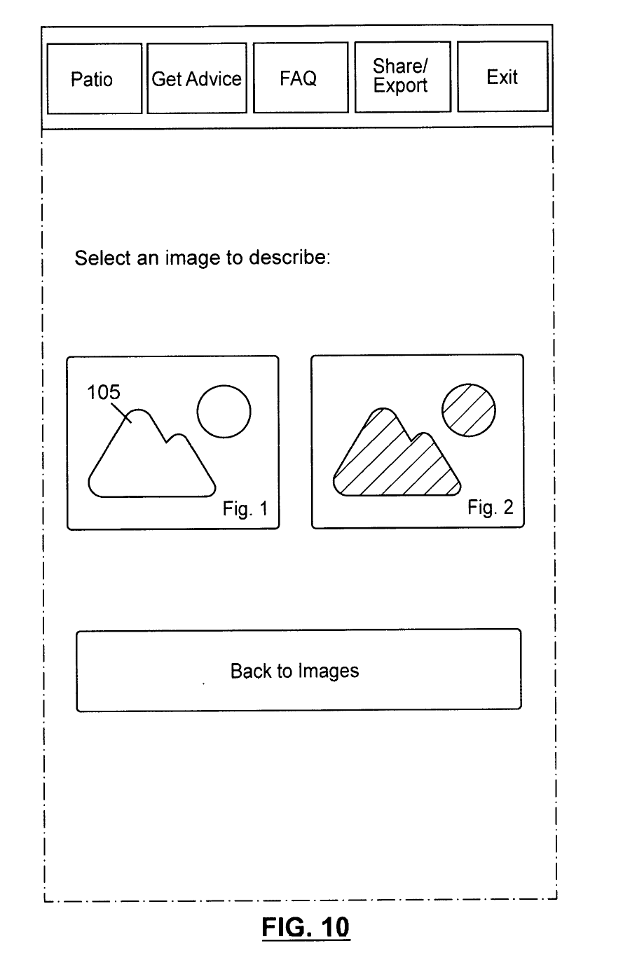

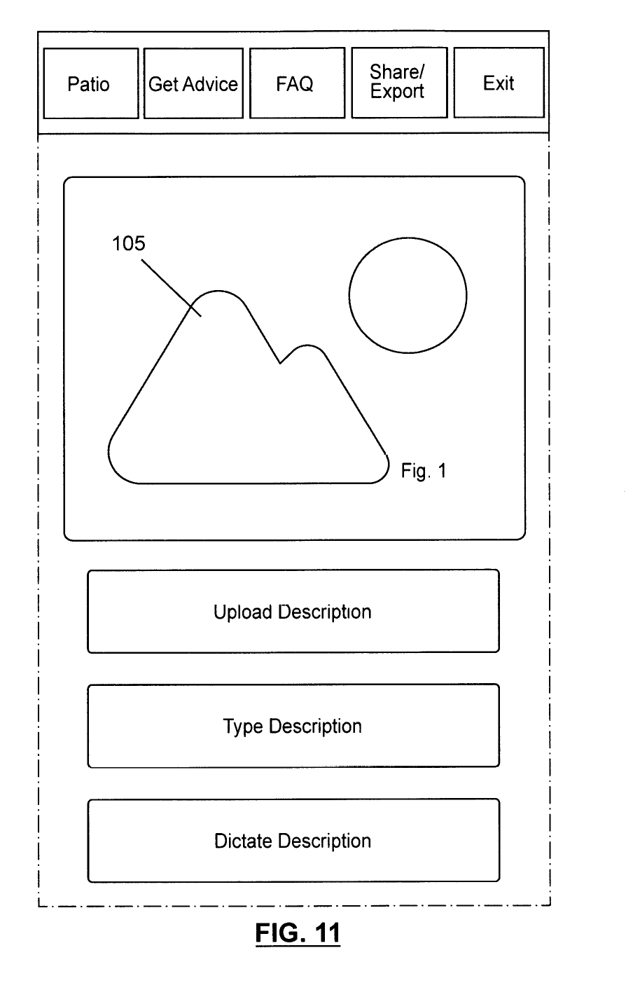

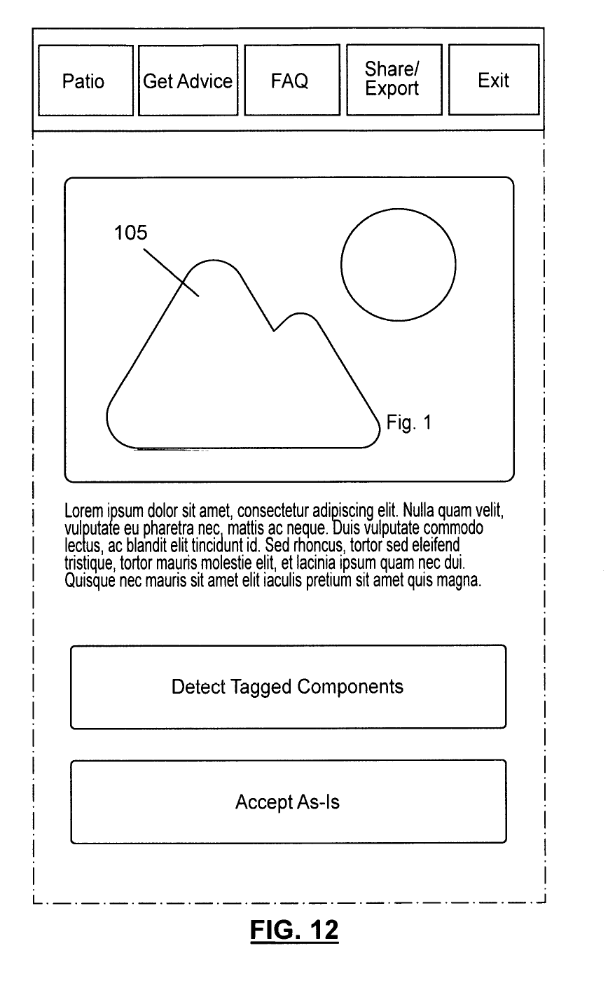

If the user selects add description, the user can be taken to FIG. 10 where the user can select which of the added drawings the description relates to. Once the user selects an image to describe, the user can be taken to FIG. 11 where the user can be given various options for adding the description, including but not hunted to uploading, typing, and dictating the description. If the user chooses to upload the description, the description can be uploaded and the user can be taken to FIG. 12 where some or all of the uploaded description can be shown. The app can then provide an option to detect the component names that the user has already entered when tagging the corresponding image. When these tagged components are detected, the app can automatically add the correct component number to the uploaded text.

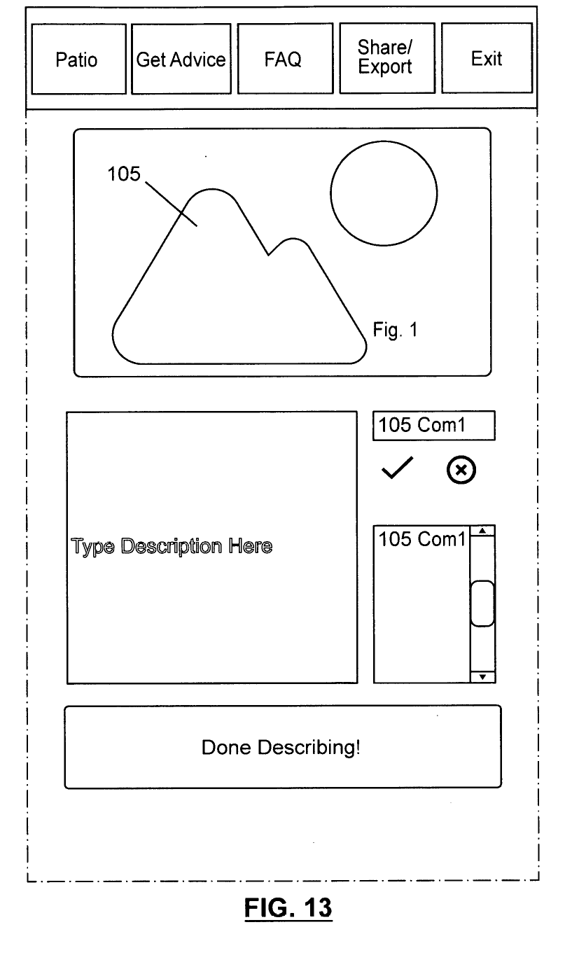

If the user chooses to type the text of the description, the user can be taken to FIG. 13, where a text box is provided for entering text. In addition, the screen can show a scrollable list of component names and numbers, from which the user can select for insertion into the text. Moreover, the app can automatically detect a component name and/or number already added during tagging as these names and/or numbers are being typed in the text box. Once a pre-entered (during tagging) component name is detected, the app can suggest and or auto-insert the component number (entered during tagging). The user can then accept this suggestion for insertion into the text (e.g. choose check mark) or reject the suggestion (e.g. choose ‘x’). A similar functionality can be provided for when a component number is detected. The user can also be provided with the option of “done describing”.

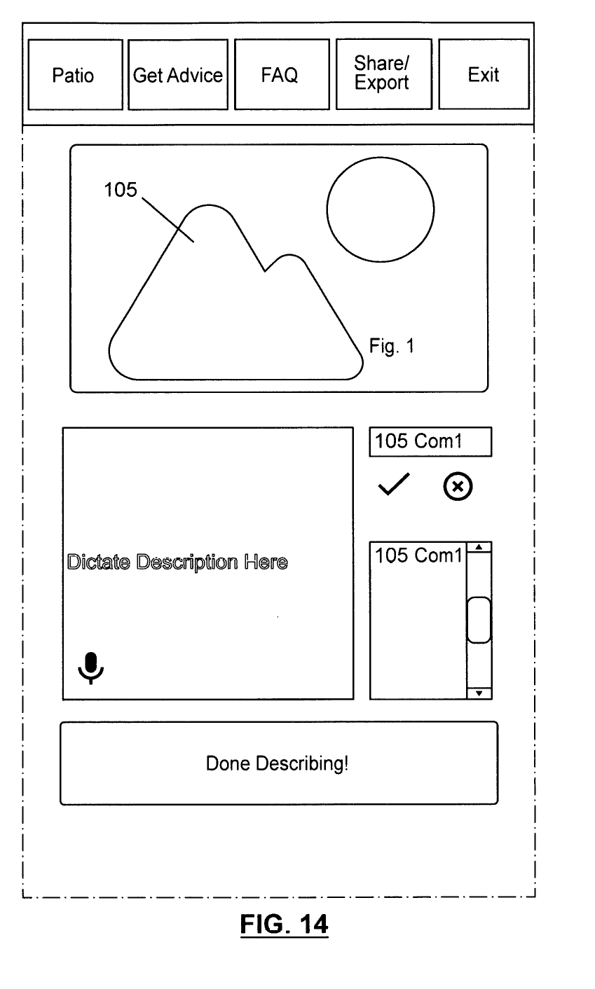

If the user chooses to dictate (i.e. voice to text) the description, the user can be taken to FIG. 14, which is similar to FIG. 13 with the difference being that text can also be entered into the text box by dictation. During dictation, dictated component names can be detected on the fly by comparing the detected text to the list of the component names entered by the user during the tagging step. Once the component names are detected, the corresponding component numbers can be suggested to the user and/or auto-inserted into the transcribed text on the fly.

When the user chooses “done describing”, the user can be taken to FIG. 14, where options can be provided to: a) add description for another drawing, b) check for missing components in description, c) check for missing components in figure, d) check for patent profanity, and d) accept the description as-is or as-entered. In option b), the app can check that there are no tagged component numbers and/or names which have not been mentioned in the description. In option c), the app can check that there are no component numbers mentioned in the description which have not been tagged in the drawings. In option d), the app can check for language that can be unduly limiting, an actual profanity, and/or any other language not suitable in a parent application.

In some implementations, the option d) can also detect trademarks and insert the TM or R-in-circle superscript to indicate that a word in the description is a trademark. For example, the app can link to the list of trademarks registered with one or more intellectual property offices to access a database of registered trademarks. Option d) can also detect customary phrases which may not be suitable for use in all jurisdictions. For example, incorporations by reference which are used in the US patent application are routinely objected to by Canadian and European patent examiners. In some implementations, the app can detect a cross-reference to a related application, and search for a corresponding incorporation by reference (IBR). If the IBR is missing, the app can suggest the IBR phrase be added, at least for US patent applications.

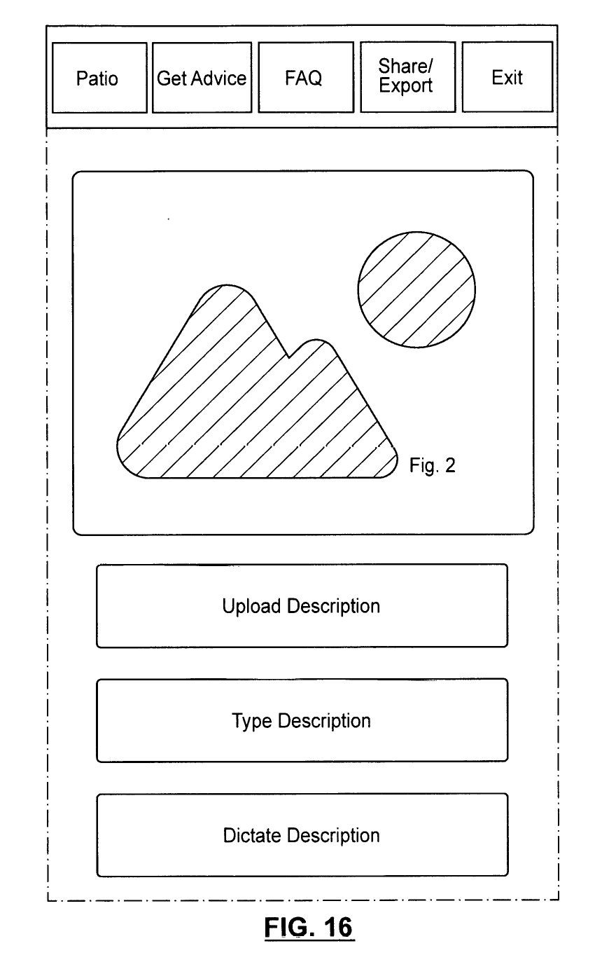

FIG. 16 gives the options for adding description for the next drawing.

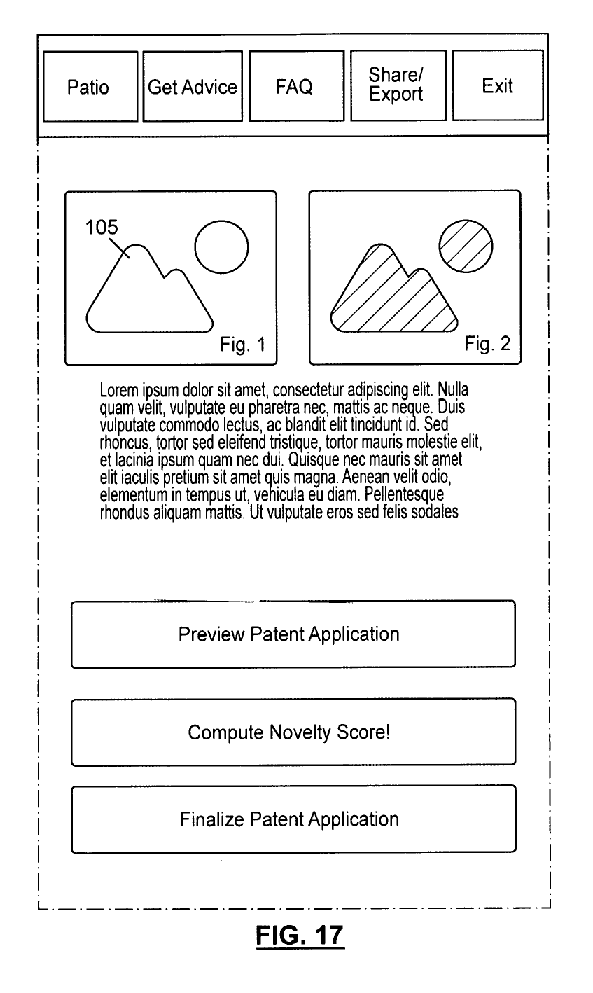

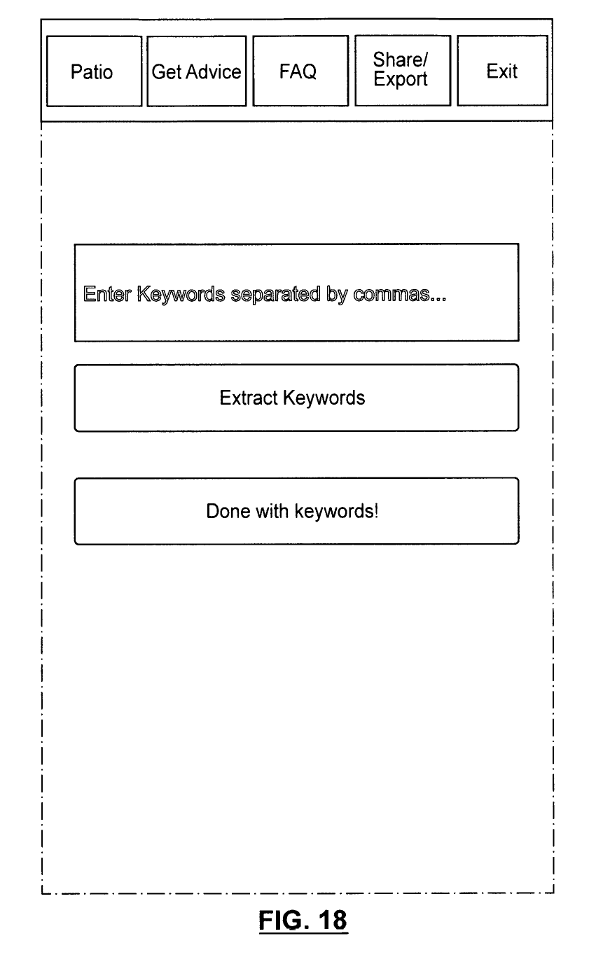

Once the description for all the drawings has been added, the user can be taken to FIG. 17 where options are provided to preview the patent application, to compute a novelty score, and to finalize the patent application. If the user chooses to compute a novelty score, then the user can be taken to FIG. 18 where keywords relating to the patent application can be determined in a number of suitable ways. For example, the user can enter the relevant keywords in a text entry box. Or, the app can automatically extract and/or suggest keywords based on the description entered already. Any suitable manner for extracting keywords can be use. For example, the app can determine the frequency of words used in the description (excluding very common words such as articles, propositions, etc. and/or other common words such as system, method, device, etc.) and can extract as the keywords those words whose frequency of occurrence excess a given threshold.

In other implementations, machine learning neural networks or other machine learning architectures can be trained on data sets that correlate the contents of a patent to a selection of keywords or patent classifications. For example, patent databases such as the US, European, or PCT patent databases can be used to train the machine learning engines on correlations between the context of all or a part (e.g. abstract, summary, claims) of a patent application and a patent classification. Then the trained engine can be used whereby the user-entered description is input in the engine, and then the engine suggests keywords or classifications related to the patent application. Other known methods for extracting keywords can also be used.

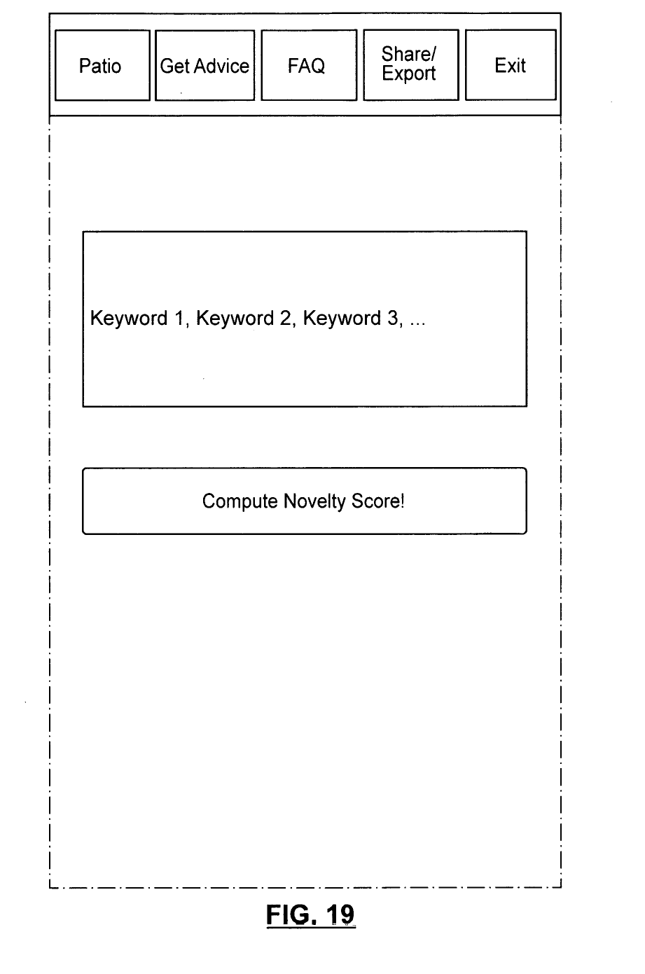

FIG. 19 shows a screen where the keywords (be they user-entered or machine-extracted) for user's review and/or revision. Once the keywords are finalized, the user can choose to compute the novelty score. The novelty score can be a measure of the number, date, and/or relevance of other similar prior art references that can be found using the keywords. For example, the app can access a database of patent documents (and/or other publications) and conduct a search using the keywords. In some implementations, the search is only done in the title author and/or in the abstract the prior art documents to increase potential relevance. In other implementations, a relevance score is assigned to the prior art search results, e.g. based on frequency of occurrence of the keywords in the prior art reference, etc. Those references that exceed a given threshold of relevance are then counted as relevant prior art references. Other ways of determining the novelty score can also be used.

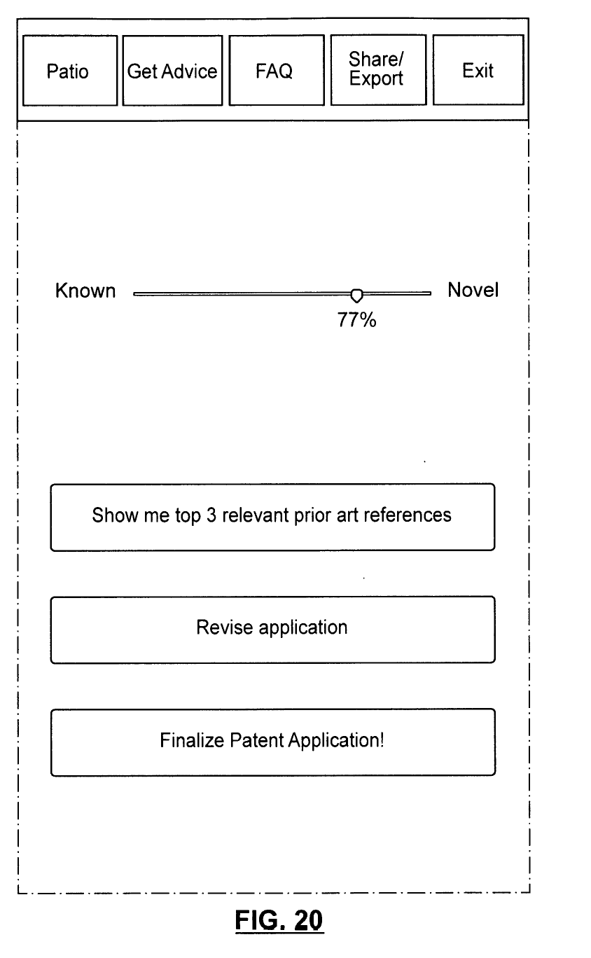

Based on the number of relevant prior art references found using the keywords, the app can assign a novelty score to the application, as shown in FIG. 20. While the novelty score is displayed as a percentage on a slider, other ways of displaying the novelty score are also contemplated. For example, red, yellow, and green colors can be used to signify the number and/or the relevance of the prior art that has been found, and to suggest to the user whether she should proceed with filing or should review some of the references before proceeding.

In some implementations, based on the novelty score, the app can cause the mobile device to emit as visual, audio, or palpable/taptic/haptic feedback based on the novelty score. E.g. the app can sound a buzzer and/or vibrate if the novelty score is low (many relevant references have been found) or display a green light (or a congratulatory jingle) if the novelty score is high (i.e. few or no relevant prior art reference have been found.

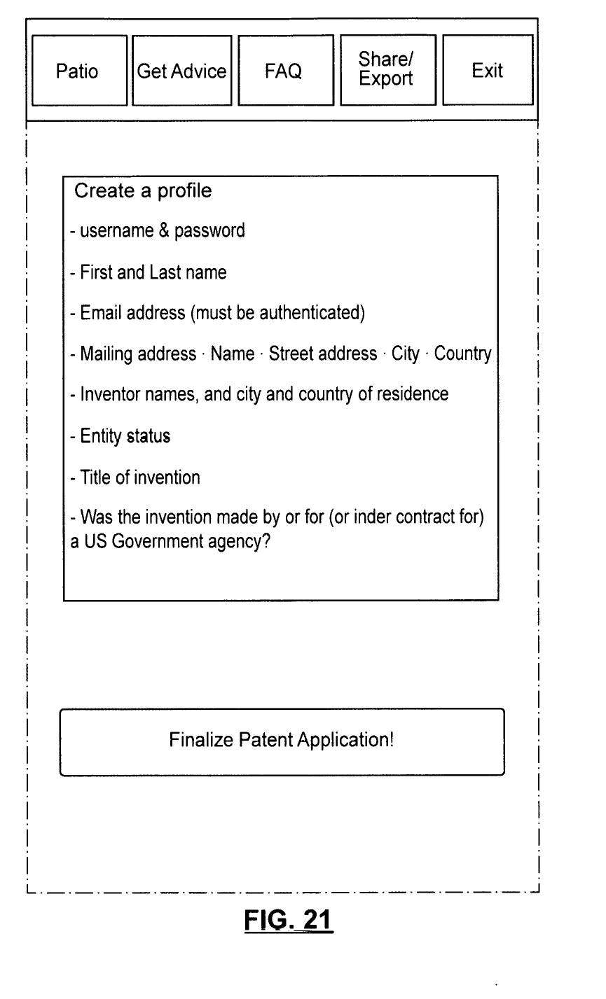

FIG. 2 can also provide the option for the user to be directed to or provided with a given number of the relevant prior art reference(s) to review, and also the options to then either revise or finalize the patent application. If the user chooses to finalize, then the user can be taken to FIG. 21 to provide biographical information which then can be used when filing the patent application with a given patent office.

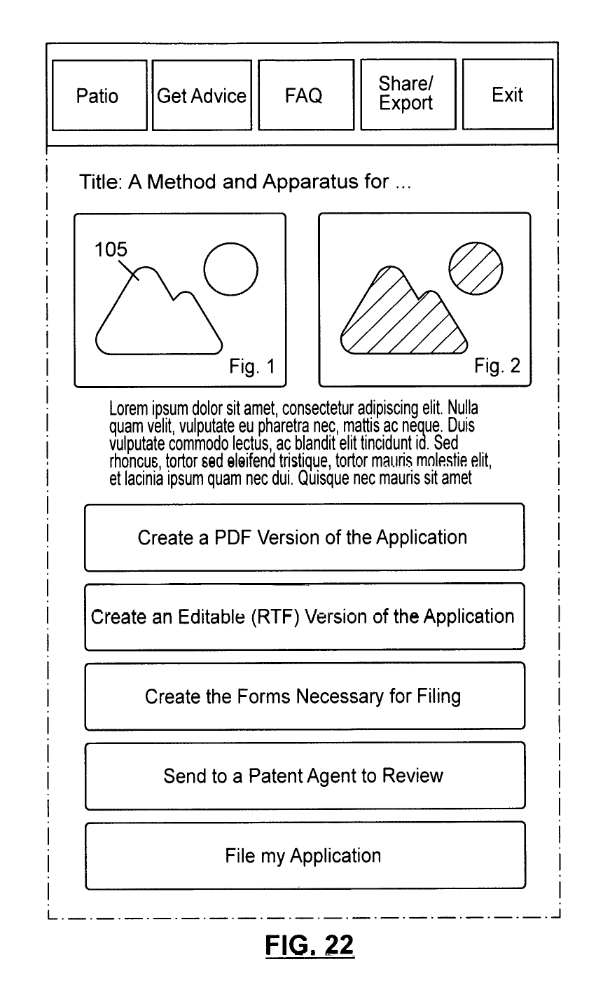

After the biographical information has been provided and the patent application preparation has been finalized, then the user can be taken to FIG. 22 where the user can be presented with the following options: i) create a PDF version of the application, ii) create an editable version of the application, iii) create the forms necessary when filing a patent application, iv) send the draft patent application to a qualified patent agent to review, and v) file the application with a patent office.

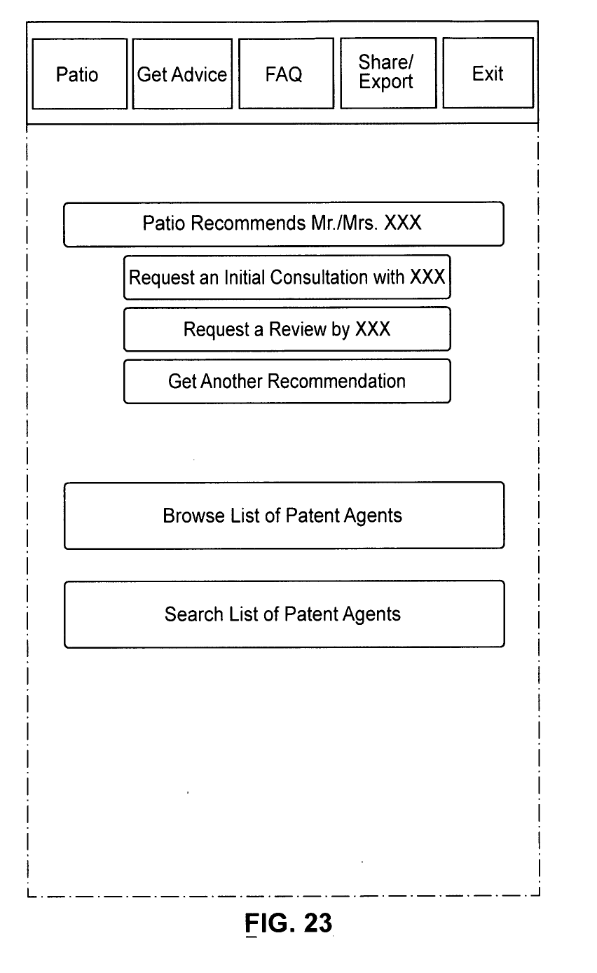

If the user chooses iv), the user can be taken to FIG. 23, which has many similarities with FIG. 24, already discussed. In FIG. 23, the app can suggest a patent agent and can provide the user with options to request an initial consultation, request a review, or met another recommendation for a patent agent. For the patent agents who sign up with the app, price lists and or client lists can be provided to the app, so quotes can be provided automatically and/or conflict checks can be performed automatically.

Moreover, subscribing patent agents can provide access to their work calendars anchor can provide their availability for meetings, and the app can activate calendar/scheduling engine to automatically schedule a consult with the recommended patent agent at a time there are indicated as being available for such meetings.

Furthermore, the keyword and/or patent classification capture and/or discovery functionality described above can be used to match a particular application with technical background and/or areas of practice of patent agents as part of recommending agents to the user. In this manner, the app can assist the user by recommending agents whose technical background and/or areas of practice and experience overlap with the technical subject matter of the patent application being prepared.

Referring back to FIG. 22, if the user chooses to file the patent application, the app can interface with the filing portals of the target patent office, collect and/or calculate the filing costs for the user, and automatically submit the patent application, the fees, and/or the necessary forms through the portal.

Once the application has been filed, the app can save them in a database. The system of this specification can comprise a viewing and electronic transaction/auction interface that can allow other patent agents (who have passed conflict checks and/or meet other qualification criteria set by the user) to view this first patent filing and bid for the rights to do one or more of 1) formalize a provisional application, 2) file Paris Convention application(s) in other jurisdictions within a year of the first filing, 3) file national and/or regional phase entries of a PCT application, 4) file divisionals, continuations, and/or continuations-in-part of the application, and the like. In addition, investors or any other interested parties can also search, browse, and/or otherwise review the filed applications and bid to buy or license these applications. The app, and/or the system of this specification, can charge a percentage of each of these transactions. In some implementations, the system can also charge a subscription fee for patent agents, investors, or other interested parties to access the patent applications prepared and/or filed using the app.

In some implementations, the filed patent application can comprise a US provisional application and/or a PCT patent application.

In the foregoing, references to the riser being provided with options or taken to screens can include the system of the present specification (i.e. the app and/or the computing devices and networks on which the app runs) generating and displaying those options and/or the system of the present specification generating and displaying screens (as part of the graphical user interface displayed at the mobile device), which new screens then the user can interact with.

Moreover, the references in the foregoing to various screens presenting corresponding functionality and the user moving between the screens to disclose the general features and functionality of the systems and methods described herein. The specific appearance, content, and/or configuration of the screen captures and the precise order of user's progression between the screens described herein is exemplary only and non-limiting. It is contemplated that other implementations of the systems and methods described herein can be implemented using user interfaces that have appearance, content, and/or configuration different than those described and shown herein. Moreover, it is contemplated that in other implementations a user can move and/or progress through the various functionalities and screens in an order that is different than the one described herein.

The following concepts and disclosures are also contemplated herein:

1. A system for preparing a patent application, the system comprising:
an image processing engine;
a text processing engine;
an input terminal in communication with the text processing engine and the image processing engine;
a memory in communication with one or more of the image processing engine, the text processing engine, and the input terminal, the memory configured for storing one or more of text data and image data;
typesetting engine;
wherein:
   the input terminal is configured to receive one or more of image data and text data, and to communicate the image data and the text data to one or more of the image processing engine, the text processing engine, and the memory;
   the image processing engine is configured to receive the image data from one or more of the input terminal and the memory, and to process the image data to generate processed image data comprising one or more of:
      figure numbers added to the image data;
      lead lines added to the image data; and
      component numbers added to the image data;
   the text processing engine is configured to receive the text data from one or more of the input terminal and the memory, and to process the text data to generate processed text data comprising the text data formatted as a description corresponding to the image data; and
   the typesetting engine is configured to arrange the processed image data and the processed text data to generate a document in a format acceptable by a given patent office.

2. The system of concept1, wherein one or more of the image processing engine, the text processing engine, and the typesetting engine comprises one or more of:
a processor of a front end computing device or a back end system;
a CPU of the front end computing device or the back end system;
a GPU of the front end computing device or the back end system;
a neural processor of the front end computing device or the back end system; and
a quantum computing processor of the front end computing device or the back end system.

3. The system of concept 2, wherein the front end computing device comprises a mobile computing device.

4. The system of concept 2, wherein the bank end system comprises on more of:
one or more servers;
a cloud computing engine.

5. The system of any one of concepts 1 to 4, wherein the input terminal comprises a mobile computing device.

6. The system of concept 5, wherein the mobile computing device comprises one or more of a touch screen, a camera, and a microphone.

7. The system of any one of concepts 1 to 6, wherein receiving the image data comprises one or more of:
retrieving the image data from an image library; and
capturing the image data using a camera.

8. The system of any one of concepts 1 to 7, wherein receiving the text data comprises one or more of:
retrieving the text data from a corresponding memory;
capturing typed text data;
capturing and transcribing voice dictation.

9. The system of any one of concepts 1 to 8, wherein processing the image data further comprises the image processing engine generating a black-and-white line drawing based on the image data.

10. The system of any one of concepts 1 to 9, wherein the input terminal is further configured to receive component names corresponding to the various components described by the image data.

11. The system of concept 10, wherein the input terminal is further configured to send the component names to the memory, and the memory is configured to store the component names.

12. The system of concept 10, wherein the image processing engine is configured to auto-assign component numbers to each of the component names, and the memory is configured to store the component numbers in association with the component names.

13. The system of concept 12, wherein the image processing engine is configured to auto-increment the component numbers.

14. The system of concept 12, wherein the image processing engine is configured to auto-assign the component numbers for components of a given figure described by the image data to have leading digits the same as a figure number of the given figure.

15. The system of concept 12, wherein processing the text data comprises detecting the component names in the text data and auto-filling the corresponding component numbers in the text data.

16. The system of concept 15, wherein the auto-filling is done on the fly as text data is being received.

17. The system of concept 12, wherein processing the text further comprises checking a description corresponding to each given image described in the image data to detect one or more of:
missing component names associated with the given image;
component names that are mismatched with an adjacent component number in the description;
component numbers which are stored in the memory in association with the given mage but missing from the description associated with given image; and
patent profanity.

18. The system of any one of concepts 1 to 17, wherein the format comprises one or more of PDF and Rich Text Format.

19. The system of any one of concepts 1-18, wherein one or more of the system and the processing engine is further configured to extract keywords from the text data.

20. The system of concept 19, wherein one or more of the system and the text processing engine is further configured to calculate a novelty score based on the keywords.

21. A method for preparing a patent application, the method comprising:
receiving at an input terminal one or more of image data and text data;
communicating the image data; and the text data to one or more of an image processing engine, a text processing engine, and a memory;
processing the image data at the data processing engine to generate processed image data comprising one or more of:
   figure numbers added to the image data;
   lead lines added to the image data; and
   component numbers added to the image data;
processing the text data at the text processing engine to generate processed text data comprising the text data formatted as a description corresponding to the image data; and
arranging the processed image data and the processed text data at a typesetting engine to generate a document in a format acceptable by a given patent office.

22. The method of concept 21, wherein one or more of the image processing engine, the text processing engine, and the typesetting engine comprises one or more of:
a processor of a front end computing device or a back end system;
a CPU of the front end computing device or the back end system;
a GPU of the front end computing device or the back end system;
a neural processor of the front end computing device or the back end system; and
a quantum computing processor of the front end computing device or the back end system.

23. The method of concept 22, wherein the front end computing device comprises a mobile computing device.

24. The method of concept 22, wherein the bank end system comprises on more of:
one or more servers; and
a cloud computing engine.

25. The method of any one of concepts 21 to 24, wherein the input terminal comprises a mobile computing device.

26. The method of concept 25, wherein the mobile computing device comprises one or more of a touch screen, a camera, and a microphone.

27. The method of any one of concepts 21 to 26, wherein receiving the image data comprises one of more of:
retrieving the image data from an image library; and
capturing the image data using a camera.

28. The method of any one of concepts 21 to 27, wherein receiving the text data comprises one or more of:
retrieving the text data from a corresponding memory;
capturing typed text data;
capturing and transcribing voice dictation.

29. The method of one of concepts 21 to 28, wherein processing the image data further comprises generating at the image processing engine a black-and-white line drawing based on the image data.

30. The method of any one of concepts 21 to 29, further comprising receiving at the input terminal component names corresponding to the various components described by the image data.

31. The method of concept 30, further comprising sending the component names from the input terminal to be memory, and storing the component names the memory.

32. The method of concept 30, further comprising at the image processing engine auto-assigning component numbers to each of the component names, and storing at the memory the component numbers in association with the component names.

33. The method of concept 32, wherein the alto assigning the component numbers comprises the image processing engine auto-incrementing the component numbers.

34. The method of concept 32, wherein the auto-assigning the component numbers comprises the image processing engine auto-assigning the component numbers for components of a given figure described by the image data to have leading digits the same as a figure number of the given figure.

35. The method of concept 32, wherein processing the text data comprises detecting the component names in the text data and auto-filling the corresponding component numbers in the text data.

36. The method of concept 35, wherein the auto-filling is performed on the fly as text data is being received.

37. The method of concept 32, wherein processing the text further comprises checking a description corresponding to each given image described in the image data to detect one or more of:
missing component names associated with the given image;
component names that are mismatched with an adjacent component number in the description;
component numbers which are stored the memory in association with the given image but missing from the description associated with given image; and
patent profanity.

38. The method of any one of concepts 21 to 37, wherein the forma comprises one or more of PDF and Rich Text Format.

39. The method of any one of concepts 21-38, further comprising extracting keywords from the text data at one more of the system and the text processing engine.

40. The method of concept 39, further comprising calculating a novelty score at one more of the system and the text processing engine.

41. A computer readable medium comprising computer readable instructions configured to cause a computing system to carry out the method of any one of concepts 21 to 40.

The above-described implementations are intended to be exemplary and alterations and modifications may be effected thereto, by those of skill in the art, without departing from the scope of the invention which is defined solely by the claims appended hereto.

1. A system for preparing a patent application, the system comprising:
an image processing engine;
a text processing engine;
an input terminal in communication with the text processing engine and the image processing engine;
a memory in communication with one or more of the image processing engine, the text processing engine, and the input terminal, the memory configured for storing one or more of text data and image data;
a typesetting engine;
wherein:
the input terminal is configured to receive one or more of image data and text data, and to communicate the image data and the text data to one or more of the image processing engine, the text processing engine, and the memory;
the image processing engine is configured to receive the image data from one or more of the input terminal and the memory, and to process the image data to generate processed image data comprising one or more of:
figure numbers added to the image data;
lead lines added to the image data; and
component numbers added to the image data;
the text processing engine is configured to receive the text data from one or more of the input terminal and the memory, and to process the text data to generate processed text data comprising the text data formatted as a description corresponding to the image data, and
the typesetting engine is configured to arrange the processed image data and the processed text data to generate a document in a format acceptable by a given patent office.

2. The system of claim 1, wherein one or more of the image processing engine, the text processing engine, and the typesetting engine comprises one or more of:
a processor of a front end computing device or a back end system;
a CPU of the front end computing device or the back end system;
a GPU of the front end computing device or the back end system;
a neural processor of the front end computing device or the back end system; and
a quantum computing processor of the front end computing device or the back end system.

3. The system of claim 2, wherein one or more of:
the front end computing device comprises a mobile computing device; and
the bank end system comprises one or more of:
one or more servers; and
a cloud computing engine.

4. The system of claim 1, wherein the input terminal comprises a mobile computing device.

5. The system of claim 1, wherein
the input terminal is further configured to
receive component names corresponding to the various components described by the image data; and
send the component names to the memory; and
the memory is configured to store the component names.

6. The system of claim 5, wherein the image processing engine is configured to auto-assign component numbers to each of the component names, and the memory is configured to store the component numbers in association with the component names.

7. The system of claim 62, wherein the image processing engine is configured to one or more of:
auto-increment the component numbers; and
auto-assign the component numbers for components of a given figure described by the image data to have leading digits the same as a figure number of the given figure.

8. The system of claim 6, wherein processing the text data comprises detecting the component names in the text data and auto-filling the corresponding component numbers in the text data.

9. The system of claim 8, wherein the auto-filling is done on the fly as text data is being received.

10. The systems of claim 6, wherein processing the text further comprises checking a description corresponding to each given image described in the image data to detect one or more of:
missing component names associated with the given image;
component names that are mismatched with an adjacent component number in the description;
component numbers which are stored in the memory in association with the given image but missing from the description associated with given image; and
patent profanity.

11. A method for preparing a patent application, the method comprising:
receiving at an input terminal one or more of image data and text data;
communicating the image data and the text data to one or more of an image processing engine, a text processing engine, and a memory;
processing the image data at the data processing engine to generate processed image data comprising one or more of:
figure numbers added to the image data;
lead lines added to the image data; and
component numbers added to the image data;
processing the text data at the text processing engine to generate processed text data comprising the text data formatted as a description corresponding to the image data; and
arranging the processed image data and the processed text data at a typesetting engine to generate a document in a format acceptable by a given patent office.

12. The method of claim 11, wherein one or more of the image processing engine, the text processing engine, and the typesetting engine comprises one of more of:
a processor of a front end computing device or a back end system;
a CPU of the front end computing device or the back end system;
a GPU of the front end computing device or the back end system;
a neural processor of the front end computing device or the back end system; and
a quantum computing processor of the front end computing device or the back end system.

13. The method of claim 12, wherein one or more of:
the front end computing device comprises a mobile computing device; and
the bank end system comprises on more of:
one or more servers; and
a cloud computing engine.

14. The method of claim 11, wherein the input terminal comprises a mobile computing device.

15. The method of claim 11, further comprising
receiving at the input terminal component names corresponding to the various components described by the image data;
sending the component names from the input terminal to the memory; and
storing the component names the memory.

16. The method of claim 15, further comprising at the image processing engine auto-assigning component numbers to each of the component names, and storing at the memory the component numbers in association with the component names.

17. The method of claim 16, wherein the auto-assigning the component numbers comprises the image processing engine one or more of:
auto-incrementing the component numbers; and
auto-assigning the component numbers for components of a given figure described by the image data to have leading digits the same as a figure number of the given figure.

18. The method of claim 16, wherein processing the text data comprises detecting the component names in the text data and auto-filling the corresponding component numbers in the text data on the fly.

19. The method of claim 16, wherein processing the text further comprises checking a description corresponding to each given image described in the image data to detect one or more of:
missing component names associated with the given image;
component names that are mismatched with an adjacent component number in the description;
component numbers which are stored in the memory in association with the given image but missing from the description associated with given image; and
patent profanity.

20. A computer readable medium comprising computer readable instructions configured to cause a computing system to carry out the method of claim 11.
